(19) United States
(12) Patent Application Publication
(10) Pub. No.: US 2010/0046741 A1
(43) Pub. Date: Feb. 25, 2010

(54) APPARATUS, METHOD, AND COMPUTER PROGRAM PRODUCT FOR DECRYPTING, AND APPARATUS, METHOD, AND COMPUTER PROGRAM PRODUCT FOR ENCRYPTING

(75) Inventors: Taichi ISOGAI, Tokyo (JP); Tomoko YONEMURA, Kanagawa (JP); Hirofumi MURATANI, Kanagawa (JP); Atsushi SHIMBO, Tokyo (JP); Kenji OHKUMA, Kanagawa (JP); Yuichi KOMANO, Kanagawa (JP); Kenichiro FURUTA, Tokyo (JP); Yoshikazu HANATANI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/390,732

(22) Filed: Feb. 23, 2009

(30) Foreign Application Priority Data
Aug. 25, 2008 (JP) 2008-216014

(51) Int. Cl. H04L 9/28

(52) U.S. Cl. 380/28; 380/30

(57) ABSTRACT

An input unit inputs encrypted data that elements of a subgroup and expressed in an affine representation. A transforming unit transforms the inputted encrypted data into projective representation data expressed in a projective representation. A plain data calculating unit subjects the projective representation data to a decrypting process previously defined by a cryptosystem, thereby calculating plain data expressed in the projective representation.

### CROSS-REFERENCE TO RELATED APPLICATIONS

This application is based upon and claims the benefit of priority from the prior Japanese Patent Application No. 2008-216014, filed on Aug. 25, 2008; the entire contents of which are incorporated herein by reference.

### BACKGROUND OF THE INVENTION

1. Field of the Invention

The present invention relates to an apparatus, a method, and a computer program product for encrypting or decrypting data using a public key cryptosystem that applies a discrete logarithm problem as a basis of security.

2. Description of the Related Art

The public key cryptography that enables to provide secure communications without need to previously share a key is widely used as a basic technology for network security. Information terminals have become more diversified and accordingly, methods or implementations have been devised to enable to use various schemes or protocols that use a public key also in small devices.

In the present public key cryptography, a typical cryptosystem size is 1024 bits. The cryptosystem size indicates a size of data expressed in a representation form to be used in the public key cryptography. For example, in a Cramer-Shoup cryptography, which is one type of the public key cryptosystem, various data are expressed in a representation form called extension field representation of 1024 bits. Because capabilities of attackers are enhanced with improvement of computing machines, the cryptosystem size that is considered difficult to decipher is increasing year by year. In the public key cryptography, the size of a public key or encrypted data is several times the cryptosystem size (it depends on methods to be used). For example, the public key size is a product of the cryptosystem size and the number of keys. The encrypted data size is a product of the cryptosystem size and the number of encrypted data required to encrypt one message. Therefore, in a device having an insufficient memory capacity or communication band, an increased cryptosystem size causes a problem.

Accordingly, an encryption compression technique is proposed that enables to compress the public key size or the encrypted data size in the public key cryptography (for example, “Torus-Based Cryptography”, by K. Rubin and A. Silverberg, CRYPTO 2003, Springer LNCS 2729, pp. 349 to 365, 2003). The encryption compression technique is based on a fact that when a subset called algebraic torus in a set of numbers to be used in the public key cryptography is used, elements of the set can be expressed by a smaller number of bits. A technique that enables to use an additional input when elements of a set are transformed into a representation with a smaller number of bits is also known as an improved technique for increasing a compression rate, that is, a ratio of the number of bits before compression to the number of bits after compression (for example, “Asymptotically Optimal Communication for Torus-Based Cryptography” by M. van Dijk and D. Woodruff, CRYPTO 2004, Springer LNCS 3152, pp. 157 to 178, 2004).

It is assumed here that maps for transformation into a representation with a smaller number of bits are denoted by ρ and θ, and that ρ and θ are referred to as “Rubin Silverberg (RS) compression map” and “Dijk Woodruff (DW) compression map”, respectively. Specific examples of compression of a encrypted data performed using these compression maps are explained below.

In the RS compression map, calculation according to Formula (1) is performed for an input of encrypted data c, thereby obtaining compressed encrypted data γ.

ρ(c)=γ (1)

In the DW compression map, calculation according to Formula (2) is performed for encrypted data c, which is provided as an input, using an appropriate auxiliary input a1, thereby obtaining γ and an auxiliary output a2.

θ(c, a1)=(γ, a2) (2)

It is only necessary to calculate inverse maps of ρ and θ to bring the representation back to that with the original number of bits. It is assumed that the inverse maps of ρ and θ are denoted by ρ⁻¹ and θ⁻¹, and that ρ⁻¹ and θ⁻¹ are referred to as “RS decompression map” and “DW decompression map”, respectively.

In the RS decompression map, calculation according to Formula (3) is performed for γ, which is provided as compressed encrypted data, thereby obtaining c.

ρ⁻¹(γ)=c (3)

In the DW decompression map, calculation according to Formula (4) is performed for a set of γ and a2, which is given as compressed encrypted data, thereby obtaining c and a1.

θ⁻¹(γ, a2)=(c, a1) (4)

The compression or decompression using the algebraic torus can be applied to digital signatures or exchange messages in a key exchange scheme, as well as to the public key or encrypted data in the public key cryptography.

As an example of the public key cryptography, the Cramer-Shoup cryptography is proposed in “A practical public key cryptosystem provably secure against adaptive chosen ciphertext attack, by R. Cramer and V. Shoup, CRYPTO 1998, LNCS 1462, pp. 13 to 25, 1998”. The security of a standard model of the Cramer-Shoup cryptography is certificated. The Cramer-Shoup cryptography is characterized in that the number of elements (components) of a public key or encrypted data is large. The specification of U.S. Pat. No. 7,221,758 proposes a method that enables to reduce the number of secret keys, as a variation of the Cramer-Shoup cryptography.

A encrypted data of the Cramer-Shoup cryptography has four components (c1, c2, c3, c4). Similarly, a public key of the Cramer-Shoup cryptography also has four components. The Cramer-Shoup cryptography has a problem in that each component is expressed in a representation having a data size larger than a group that is actually used for encryption. That is, the Cramer-Shoup cryptography is defined on a prime order subgroup G of a finite group G˜, while the component of the public key or encrypted data is expressed by a representation of the finite group G˜. Specifically, the Cramer-Shoup cryptography is defined by a prime order subgroup of a multiplicative group of a prime field, while the component of the public key or encrypted data is expressed by a representation of the prime field.

A field is a set of numbers for which four arithmetic operations can be defined. When a set of numbers is finite, such a field is called finite field. It is known that the number of elements included in a finite field is a prime or a power of a prime. The fields including a prime number of elements and a power of a prime number of elements are called prime field and extension field, respectively. The prime that defines the number of elements in the prime field or the extension field is called characteristic, and the power is called extension degree. The multiplicative group is a set of numbers for which multiplication and division can be defined. It is known that when 0 (zero) is eliminated from elements of a finite field, a multiplicative group is obtained. The number of elements in a group is called order.

When an algebraic torus on an extension field is denoted by T, there are smaller tori as subgroups of T. When the finite group G˜ is a multiplicative group of an extension field F, a torus T among the smaller tori, which is not included in a proper subfield of the extension field F, is determined, and its degree is a degree of the extension field F. Because t is a subgroup of T, a public key or encrypted data is expressed in the size of the torus T when a cryptosystem is defined on a prime order subgroup of the torus T. A degree of the torus T that enables to configure a compression/decompression map is obtained, and a degree and a characteristic of the extension field F for which the torus T is defined are obtained according to requirements for security.

If a prime order subgroup G is included in a proper subfield F′ of the extension field F, security of the prime order subgroup G depends on the size of the proper subfield F′. That is, the level of security is lowered by a difference in sizes. When F=F′, that is, the prime order subgroup G is a subgroup of the torus T, the cryptosystem is defined on the prime order subgroup G of the torus T without lowering the original level of security of the extension field F. On the other hand, when the proper subfield F′ has a sufficiently large size even when F>F′, compression at a compression rate (=size of F′/size of T), which is lower than the maximum compression rate (=size of F/size of T) of the algebraic torus T but sufficiently high, can be achieved.

However, when the encryption compression technique such as that of Rubin or that of M. van Dijk is used, a compressing process or a decompressing process is required in addition to an encrypting process or a decrypting process. Therefore, calculation costs are usually increased as compared to a case in which the encryption compression technique is not used.

### SUMMARY OF THE INVENTION

According to one aspect of the present invention, an encrypting apparatus that encrypts plain data by a cryptosystem based on a discrete logarithm problem on a subgroup of a multiplicative group, the apparatus includes an input unit that inputs the plain data and encryption key data, the encryption key data including components at least a part of which is a element of the subgroup and expressed in an affine representation; a first transforming unit that transforms the component expressed in the affine representation into a component expressed in a projective representation; an encrypted data calculating unit that subjects the plain data to an encrypting process previously defined by the cryptosystem using the encryption key data including the component expressed in the projective representation, thereby calculating encrypted data expressed in the projective representation; and a second transforming unit that transforms at least a part of the encrypted data expressed in the projective representation into the affine representation.

According to another aspect of the present invention, a decrypting apparatus that decrypts encrypted data encrypted by a cryptosystem based on a discrete logarithm problem on a subgroup of a multiplicative group, the apparatus includes an input unit that inputs the encrypted data including at least a component that is a element of the subgroup and expressed in an affine representation; a transforming unit that transforms the encrypted data into projective representation data expressed in a projective representation; and a plain data calculating unit that subjects the projective representation data to a decrypting process previously defined by the cryptosystem, thereby calculating decrypted plain data expressed in the projective representation.

According to still another aspect of the present invention, an encrypting method that encrypts plain data by a cryptosystem based on a discrete logarithm problem on a subgroup of a multiplicative group, the method includes inputting the plain data and encryption key data, the encryption key data including components at least a part of which is a element of the subgroup and expressed in an affine representation; transforming the component expressed in the affine representation into a component expressed in a projective representation; subjecting the plain data to an encrypting process previously defined by the cryptosystem using the encryption key data including the component expressed in the projective representation, thereby calculating encrypted data expressed in the projective representation; and transforming at least a part of the encrypted data expressed in the projective representation into the affine representation.

According to still another aspect of the present invention, a decrypting method that decrypts encrypted data encrypted by a cryptosystem based on a discrete logarithm problem on a subgroup of a multiplicative group, the method includes inputting the encrypted data that is a element of the subgroup and expressed in an affine representation; transforming the encrypted data into projective representation data expressed in a projective representation; and subjecting the projective representation data to a decrypting process previously defined by the cryptosystem, thereby calculating plain data expressed in the projective representation.

A computer program product according to still another aspect of the present invention causes a computer to perform the methods according to the present invention.

### BRIEF DESCRIPTION OF THE DRAWINGS

FIG. 1 is a block diagram of an encryption system according to a first embodiment of the present invention;

FIG. 2 is a schematic diagram for explaining an encrypting and decrypting process procedure in a Cramer-Shoup cryptosystem;

FIG. 3 is a block diagram of an encrypting apparatus according to the first embodiment;

FIG. 4 is a block diagram of a decrypting apparatus according to the first embodiment;

FIG. 5 depicts an outline of a key generating process according to the first embodiment;

FIG. 6 is a flowchart of an entire encrypting process according to the first embodiment;

FIG. 7 is a flowchart of an entire decrypting process according to the first embodiment;

FIG. 8 is a block diagram of an encryption system according to a second embodiment of the present invention;

FIG. 9 depicts an outline of a key generating process according to the second embodiment;

FIG. 10 is a block diagram of an encrypting apparatus according to the second embodiment;

FIG. 11 is a block diagram of a decrypting apparatus according to the second embodiment;

FIG. 12 is a flowchart of an entire encrypting process according to the second embodiment;

FIG. 13 is a flowchart of an entire decrypting process according to the second embodiment;

FIG. 14 is a block diagram of an encryption system according to a third embodiment of the present invention;

FIG. 15 depicts an outline of a key generating process according to the third embodiment;

FIG. 16 is a block diagram of a decrypting apparatus according to the third embodiment;

FIG. 17 is a flowchart of an entire decrypting process according to the third embodiment;

FIG. 18 is a block diagram of an encryption system according to a fourth embodiment of the present invention;

FIG. 19 depicts an outline of a key generating process according to the fourth embodiment;

FIG. 20 is a block diagram of a decrypting apparatus according to the fourth embodiment; and

FIG. 21 is a flowchart of an entire decrypting process according to the fourth embodiment.

### DETAILED DESCRIPTION OF THE INVENTION

Exemplary embodiments of an apparatus, a method, and a computer program product according to the present invention will be explained below in detail with reference to the accompanying drawings.

In the encryption compression technique that uses an algebraic torus, such as that of Rubin, encrypted data compressed into an affine representation is decompressed (transformed) into an extension field representation through a projective representation. That is, when a representation form is transformed between the affine representation and the extension field representation, the projective representation needs to be passed through. The cost required for a process of transforming between the extension field representation and the projective representation is higher than the cost required for a process of transforming between the affine representation and the projective representation. Therefore, when the process of transforming between the extension field representation and the projective representation, which requires a higher cost, is reduced as much as possible, the cost required for a computing process relating to encryption or decryption can be reduced.

Therefore, in an encryption system according to a first embodiment of the present invention, encrypted data that is compressed from the extension field representation into the affine representation according to the encryption compression technique that uses an algebraic torus is transformed into the projective representation, not into the extension field representation, thereby performing exponentiation or multiplication.

Specifically, in the first embodiment, the cost required for performing the computing process related to encryption or decryption is reduced by applying following concepts.
(1) When compression of a encrypted data is not performed, computing is performed in the extension field representation in an encrypting process or a decrypting process of the public key cryptosystem.
(2) The computing in the encrypting process or the decrypting process can be performed even in the projective representation. However, because a higher calculation cost is required, computing after transformation from the extension field representation into the projective representation is not usually performed.
(3) When compression using an algebraic torus is performed, transformation from the extension field representation into the affine representation is performed.
(4) Transformation from the affine representation into the projective representation can be performed at a low cost.
(5) Costs required for computing in the extension field representation and the projective representation are almost the same.

That is, mainly based on the concept (4), data in the affine representation is transformed into the projective representation, not into the extension field representation, and then computing is performed. Accordingly, the transforming processes at high costs are reduced, and therefore the cost for an entire computing process is lowered.

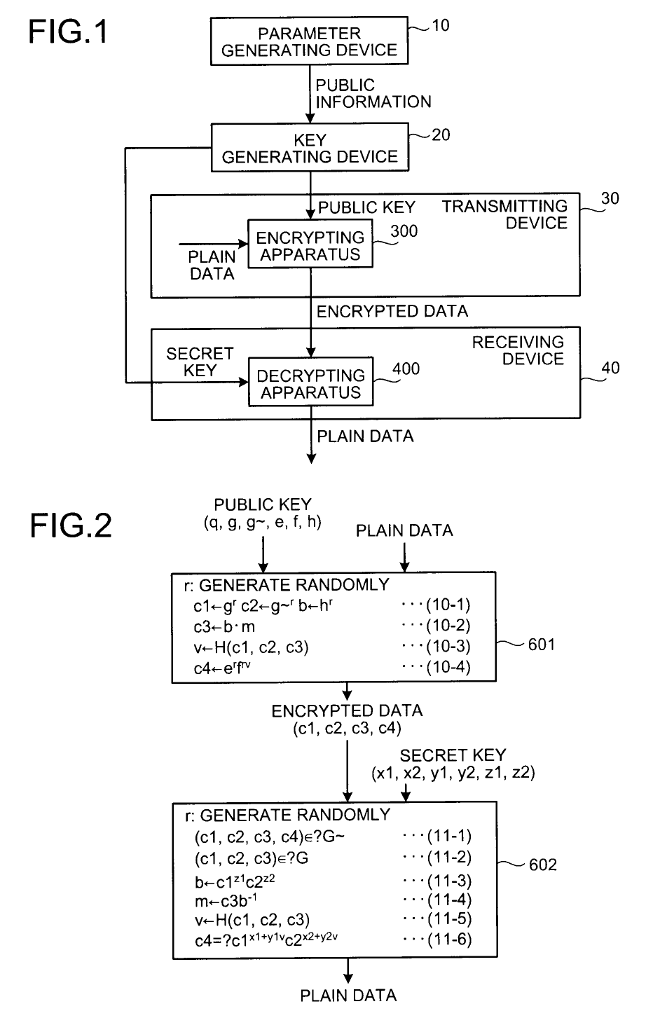

As shown in FIG. 1, the encryption system according to the first embodiment includes a parameter generating device 10, a key generating device 20, a transmitting device 30, and a receiving device 40.

The parameter generating device 10 generates public information related to the public key cryptography. The public information includes information such as elements of a group and a hash function, and information of an order and a generator as information related to a group for which a cryptosystem is defined.

The key generating device 20 generates a public key and a secret key corresponding to the public key, using the public information generated by the parameter generating device 10.

The public key generated by the key generating device 20 and plain data as a target for encryption are inputted to the transmitting device 30 that includes an encrypting apparatus 300. The plain data can be previously stored in the transmitting device 30, generated by the transmitting device 30, received from another communicating device, or read from a storage medium.

The encrypting apparatus 300 encrypts the plain data using the public key to generate encrypted data, and transmits the generated encrypted data to the receiving device 40. Details of the encrypting apparatus 300 are explained later.

Upon receipt of the encrypted data, the receiving device 40 that includes a decrypting apparatus 400 decrypts the encrypted data using the secret key corresponding to the public key used in the encryption of the encrypted data, thereby obtaining the plain data.

The transmitting device 30 and the receiving device 40 can be personal computers (PC) that are connected to each other through a network such as the Internet (not shown), for example. The transmitting device 30 includes a transmitting/receiving unit (not shown) that receives the public key from the key generating device 20 or transmits the encrypted data to the receiving device 40, and the like. Similarly, the receiving device 40 includes a transmitting/receiving unit (not shown) that receives the secret key from the key generating device 20 or receives the encrypted data from the transmitting device 30, and the like.

The encrypting apparatus 300 and the decrypting apparatus 400 apply the Cramer-Shoup cryptography as an encrypting method. This is not the only applicable encrypting method, and any encrypting method such as ElGamal cryptography can be applied as long as it is based on the discrete logarithm problem on a finite field.

In the first embodiment, the configuration in which the encrypting apparatus 300 and the decrypting apparatus 400 are included in the transmitting device 30 and the receiving device 40, respectively, is explained as an example. However, the device configuration is not limited thereto. For example, the encrypting apparatus 300 and the decrypting apparatus 400 can be included in devices other than the transmitting device 30 and the receiving device 40. The encrypting apparatus 300 and the decrypting apparatus 400 can be included in the same device.

The Cramer-Shoup cryptosystem is explained. In FIG. 2, q denotes a prime, g denotes a generator of a group G (the order of which is q) for which a cipher is defined, and g˜, e, f, and h denote elements of the group G. Plain data m is also a element of the group G, and r is a random number generated randomly.

In an encrypting process 601, encrypted data (c1, c2, c3, c4) corresponding to the plain data m are calculated according to formulas (10-1) to (10-4). In this example, H in the formula (10-3) denotes a hash function, and the encrypted data are inputted to the hash function H to obtain a hash value v. A secret key includes integers between 1 and q (or integers between 0 and q−1).

In a decrypting process 602, a check as to whether the encrypted data is valid is performed based on the secret key (x1, x2, y1, y2, z1, z2) and the encrypted data (c1, c2, c3, c4) according to formulas (11-1) to (11-6), and then the plain data m is calculated. The secret key (x1, x2, y1, y2, z1, z2) includes integers between 1 to q. In addition, cε^{?}G (or G˜) indicates a determination as to whether c belongs to a group G (or a group G˜).

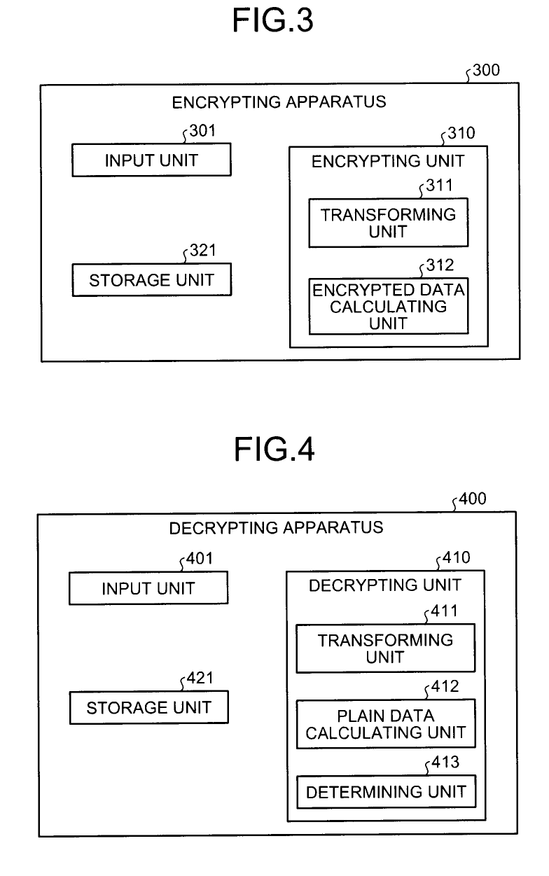

Details of the configuration of the encrypting apparatus 300 are explained. As shown in FIG. 3, the encrypting apparatus 300 includes an input unit 301, a storage unit 321, and an encrypting unit 310.

The input unit 301 inputs plain data, encryption key data of the public key cryptosystem used for encryption (hereinafter, “public key data”), and the like. The storage unit 321 stores therein the plain data and the public key data inputted.

The encrypting unit 310 performs an encrypting process for the plain data, and includes a transforming unit 311 and a encrypted data calculating unit 312.

The transforming unit 311 performs a mutual transformation between representation forms of various data to be handled in the encrypting process. For example, the transforming unit 311 transforms encrypted data expressed in the extension field representation, which is obtained by encrypting plain data, into data in the affine representation.

The encrypted data calculating unit 312 subjects the plain data to an encrypting process based on the discrete logarithm problem on a finite field using the public key data, thereby calculating encrypted data. Specifically, the encrypted data calculating unit 312 performs an encrypting process to the plain data by plural times of exponentiation or multiplication, or a hash function H that applies the encrypted data as an input value, according to the Cramer-Shoup cryptosystem, thereby outputting encrypted data. As described above, the encrypted data calculating unit 312 can be adapted to use another cryptosystem such as the ElGamal cryptosystem.

Details of the configuration of the decrypting apparatus 400 are explained. As shown in FIG. 4, the decrypting apparatus 400 includes an input unit 401, a storage unit 421, and a decrypting unit 410.

The input unit 401 inputs the encrypted data compressed in the affine representation by the encrypting apparatus 300, secret key data of the public key cryptosystem used for decryption, and the like. The storage unit 421 stores therein the encrypted data and the secret key data inputted.

The decrypting unit 410 performs a decrypting process for the encrypted data, and includes a transforming unit 411, a plain data calculating unit 412, and a determining unit 413.

The transforming unit 411 performs a mutual transformation between representation forms of various data to be handled in a decrypting process. For example, the transforming unit 411 transforms the compressed encrypted data in the affine representation, into the projective representation. The encrypted data expressed in the projective representation is hereinafter sometimes referred to “projective representation data”.

The plain data calculating unit 412 subjects the encrypted data to a decrypting process based on the discrete logarithm problem on a finite field using the secret key data, thereby calculating the plain data. Specifically, the plain data calculating unit 412 performs the decrypting process for the encrypted data by plural times of exponentiation or multiplication, or the hash function H that applies the encrypted data as an input value, according to the Cramer-Shoup cryptosystem, thereby outputting the plain data. As described above, the plain data calculating unit 412 can be adapted to use another cryptosystem such as the ElGamal cryptosystem.

The determining unit 413 determines validity of the encrypted data. For example, the determining unit 413 determines whether elements of the encrypted data are elements of a valid group. The determining unit 413 calculates a hash value of the inputted encrypted data, and compares a value calculated using the calculated hash value and a predetermined component of the inputted encrypted data. The determining unit 413 then determines that the encrypted data is valid based on whether the calculated value and the predetermined component are equal.

The storage units 321 and 421 can be any storage media commonly used, such as a hard disk drive (HDD), an optical disk, a memory card, or a random access memory (RAM).

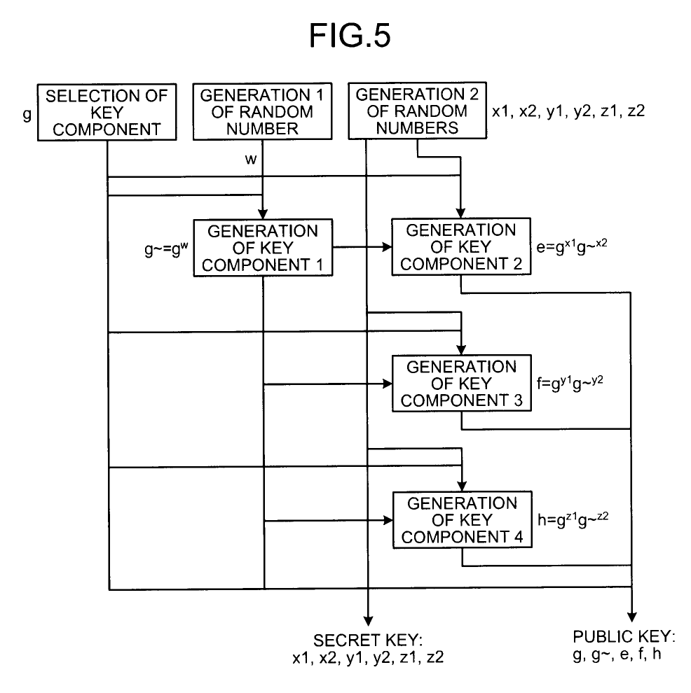

A key generating process performed by the key generating device 20 is explained next with reference to FIG. 5.

The key generating device 20 first selects a generator g, which is expressed in the extension field representation and becomes a element of a torus, as a component of the public key data. The key generating device 20 then generates random numbers other than 0 (zero), w, x1, x2, y1, y2, z1, and z2.

The key generating device 20 then generates components of the public key data, g˜=g^{w}, e=g^{x1}g˜^{x2}, f=g^{y1}g˜^{y2}, and h=g^{z1}g˜^{z2}. The key generating device 20 then outputs x1, x2, y1, y2, z1, and z2 as the secret key data, and outputs g, g˜, e, f, and h as the public key data.

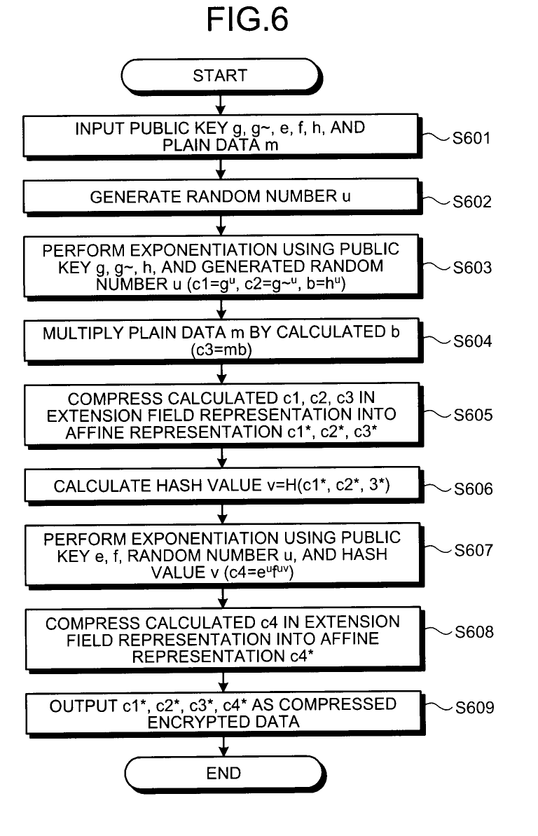

The encrypting process performed by the encrypting apparatus 300 is explained next with reference to FIG. 6.

The input unit 301 first inputs the public key data g, g˜, e, f, and h, and the plain data m (Step S601). For example, in the case of the encrypting apparatus 300 included in the transmitting device 30 as shown in FIG. 1, the input unit 301 inputs the public key data received from the key generating device 20 through the transmitting/receiving unit in the transmitting device 30 and stored in the storage unit 321, to the encrypting unit 310 from the storage unit 321. The encrypting unit 310 then generates a random number u (Step S602).

The encrypted data calculating unit 312 then performs exponentiation c1=g^{u}, c2=g˜^{u}, and b=h^{u} using g, g˜, and h of the public key data and the random number u (Step S603). The encrypted data calculating unit 312 then multiplies the plain data m by the calculated b, thereby calculating c3=mb (Step S604).

The transforming unit 311 then compresses (transforms) c1, c2, and c3 expressed in the extension field representation into the affine representation c1*, c2*, and c3*, respectively (Step S605).

It is assumed hereinafter that a variable attached with a symbol “*” indicates data expressed in the affine representation. Similarly, it is assumed that a variable attached with a symbol “′” indicates data expressed in the projective representation, and that a variable not attached with the symbol “*” or “′” indicates data expressed in the extension field representation. For example, when c1 is a variable in the extension field representation, c1* and c1′ indicate variables that express c1 in the affine representation and the projective representation, respectively.

The encrypting unit 310 then calculates a hash value v=H(c1*, c2*, c3*) using c1*, c2*, and c3* as inputs to the hash function H (Step S606). The encrypted data calculating unit 312 performs exponentiation c4=e^{u}f^{uv} using e and f of the public key data, the random number u, and the calculated hash value v (Step S607).

The transforming unit 311 then compresses (transforms) c4 expressed in the extension field representation into the affine representation c4* (Step S608). The encrypting unit 310 finally outputs calculated (c1*, c2*, c3*, c4*) as encrypted data (compressed encrypted data) (Step S609), and then terminates the encrypting process. When the encrypted data is generated in the transmitting device 30 as shown in FIG. 1, the transmitting/receiving unit of the transmitting device 30 transmits the encrypted data to the receiving device 40, or the like.

In this way, the encrypting apparatus 300 according to the first embodiment applies the encryption compression technique that uses the algebraic torus, such as that of Rubin or M. van Dijk, to the Cramer-Shoup cryptosystem described by Cramer, thereby generating the encrypted data corresponding to the plain data.

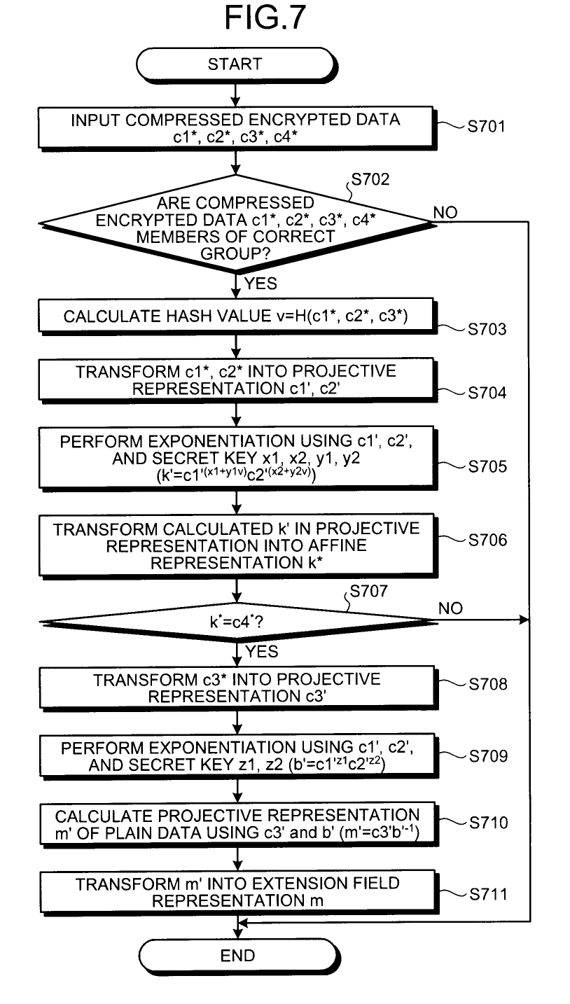

The decrypting process performed by the decrypting apparatus 400 is explained next with reference to FIG. 7.

The input unit 401 first inputs the encrypted data (compressed encrypted data) to be decrypted (Step S701). For example, in the case of the decrypting apparatus 400 included in the receiving device 40 as shown in FIG. 1, the input unit 401 inputs the encrypted data received from the transmitting device 30 through the transmitting/receiving unit of the receiving device 40 and stored in the storage unit 421, to the decrypting unit 410 from the storage unit 421.

The determining unit 413 then determines whether c1*, c2*, c3*, and c4* as components (elements) of the encrypted data are elements of a valid group, respectively, that is, whether c1*, c2*, c3*, and c4* are elements of the group G, respectively (Step S702).

In the normal Cramer-Shoup cryptosystem, it is required to confirm that c1, c2, and c3 are elements of a torus, and that c4 is a element of an extension field. In the first embodiment, because c1, c2, c3, and c4 are expressed in the affine representation, it is only necessary to confirm whether c4 is also a element of the torus, that is, c4 is expressed in a valid affine representation.

When it is determined that the components of the encrypted data are not elements of the valid group (NO at Step S702), the decrypting process is terminated.

When it is determined that the components of the encrypted data are elements of the valid group (YES at Step S702), the decrypting unit 410 calculates a hash value v=H(c1*, c2*, c3*) using c1*, c2*, and c3* as inputs to the hash function H (Step S703).

The transforming unit 411 then transforms c1* and c2* expressed in the affine representation, into components c1′ and c2′ of projective representation data (Step S704). The plain data calculating unit 412 performs exponentiation k′=c1′^{(x1+y1v)}c2′^{(x2+y2v)} using the hash value v, c1′ and c2′, and x1, x2, y1, and y2 of the secret key data (Step S705). The transforming unit 411 then transforms k′ expressed in the projective representation, into the affine representation k* (Step S706).

The determining unit 413 then determines whether k* and c4* of the components of the inputted encrypted data coincide with each other (Step S707). At Step S707, it is only necessary to confirm that k* and c4* are equivalent. Therefore, the projective representation k′ can be transformed into the extension field representation k, instead of the affine representation k*, to confirm that k and c4 coincide with each other.

When k* and c4* do not coincide with each other (NO at Step S707), the decrypting process is terminated. When k* and c4* coincide with each other (YES at Step S707), the transforming unit 411 transforms c3* expressed in the affine representation into a component c3′ of the projective representation data (Step S708). The plain data calculating unit 412 then performs exponentiation bα=c1′^{z1}c2′^{z2} using c1′ and c2′, and z1 and z2 of the secret key data (Step S709).

The plain data calculating unit 412 then calculates plain data expressed in the projective representation m′=c3′b′⁻¹ using c3′ obtained by the transformation and the calculated b′ (Step S710). The transforming unit 411 finally transforms the plain data m′ into the plain data m expressed in the extension field representation (Step S711), and then terminates the decrypting process.

The representation forms of the input data to the hash function H can be different in the encrypting apparatus 300 and the decrypting apparatus 400 so long as the outputs v of the hash function H have the same value. In the above example, the input data expressed in the affine representation are used for both devices. However, the projective representation or the extension field representation can be inputted so long as the same output can be obtained.

In this way, in the decrypting apparatus according to the first embodiment, the encrypted data compressed in the affine representation can be transformed to the projective representation, instead of the extension field representation, to perform the exponentiation or multiplication. Accordingly, the need for transformation (decompression) of the encrypted data into the extension field representation, which requires a higher calculation cost, is eliminated, and therefore the computing cost required in the public key cryptosystem that involves compression using the algebraic torus can be reduced. Particularly, in the Cramer-Shoup cryptography, because the encrypted data includes four components, effects of the reduction in the calculation cost are especially larger as compared to a case where the four components are decompressed and then decrypted, respectively.

In the first embodiment, the public key data expressed in the extension field representation is used. An encryption system according to a second embodiment of the present invention uses the public key data compressed in the affine representation.

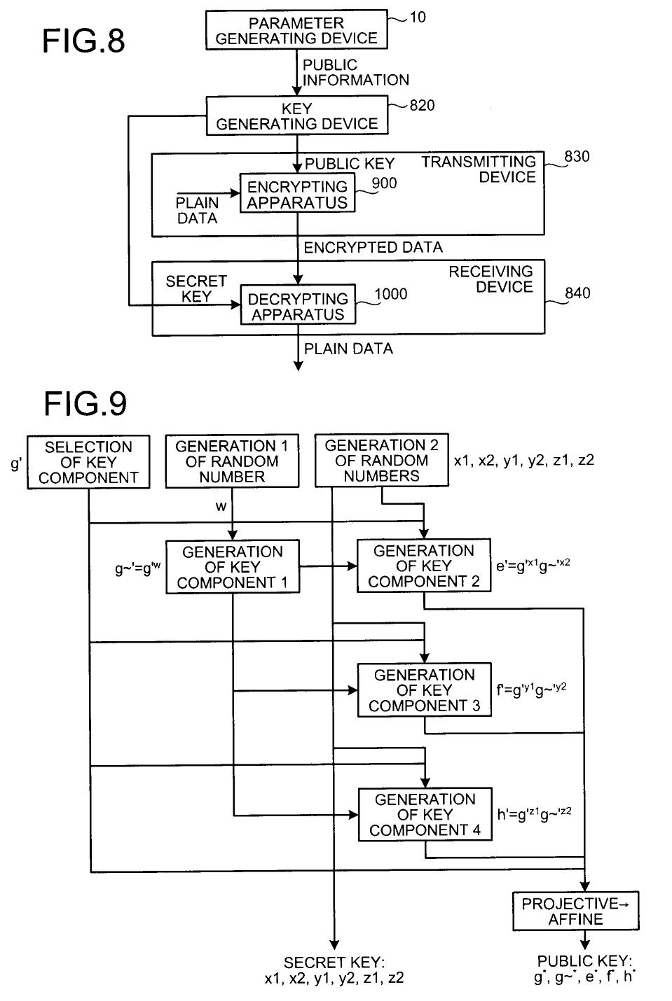

As shown in FIG. 8, the encryption system according to the second embodiment includes the parameter generating device 10, a key generating device 820, a transmitting device 830, and a receiving device 840.

In the second embodiment, functions of the key generating device 820, the transmitting device 830, and the receiving device 840 are different from those in the first embodiment. The configuration and function of the parameter generating device 10 are the same as those shown in FIG. 1, which is the block diagram of the encryption system according to the first embodiment, and thus denoted by like reference numerals and redundant explanations thereof will be omitted.

The key generating device 820 is different from the key generating device 20 according to the first embodiment in that the device 820 generates a public key expressed in the affine representation using the public information generated by the parameter generating device 10.

A key generating process performed by the key generating device 820 is explained next with reference to FIG. 9.

The key generating device 820 first selects g′ expressed in the projective representation. The key generating device 820 then generates random numbers other than zero, w, x1, x2, y1, y2, z1, and z2.

The key generating device 820 then generates g˜′=g′^{w}, e′=g′^{x1}g˜^{x2}, f′=g′^{y1}g˜^{y2}, and h′=g′^{z1}g˜^{z2}, which are components of public key data and expressed in the projective representation. The key generating device 820 then transforms the public key data g′, g˜′, e′, f′, and h′ expressed in the projective representation into public key data g*, g˜*, e*, f*, and h* expressed in the affine representation, respectively. The key generating device 820 finally outputs secret key data x1, x2, y1, y2, z1, and z2, and the public key data g*, g˜*, e*, f*, and h* expressed in the affine representation.

As described above, the second embodiment is different from the first embodiment in that the key component g′ is selected from the projective representation, and that the subsequent computing is performed with the projective representation to transform the public key data expressed in the projective representation into the affine representation. Accordingly, the size of the public key data to be distributed can be also compressed.

The transmitting device 830 and the receiving device 840 include an encrypting apparatus 900 and a decrypting apparatus 1000 (which are explained below), respectively.

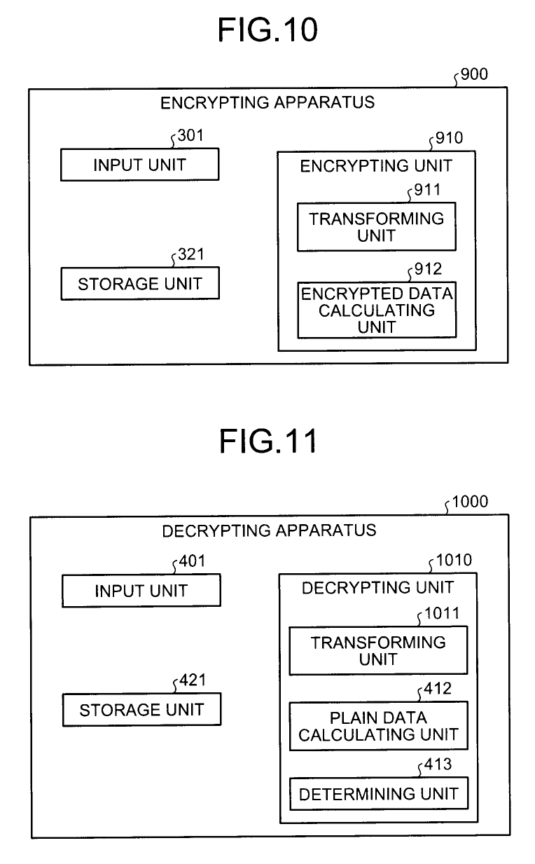

As shown in FIG. 10, the encrypting apparatus 900 includes the input unit 301, the storage unit 321, and an encrypting unit 910.

In the second embodiment, functions of a transforming unit 911 and a encrypted data calculating unit 912 in the encrypting unit 910 are different from those in the first embodiment. Other components and functions are the same as those in FIG. 3, which is the block diagram of the configuration of the encrypting apparatus 300 according to the first embodiment, and thus denoted by like reference numerals and redundant explanations thereof will be omitted.

The transforming unit 911 performs mutual transformation between representation forms of various data to be handled in an encrypting process. The transforming unit 911 has an additional function of transforming the public key data expressed in the affine representation into the projective representation.

The encrypted data calculating unit 912 subjects the plain data to the encrypting process based on the discrete logarithm problem on a finite field using the public key data transformed from the affine representation into the projective representation, to calculate encrypted data expressed in the projective representation.

As shown in FIG. 11, the decrypting apparatus 1000 includes the input unit 401, the storage unit 421, and a decrypting unit 1010.

In the second embodiment, a function of a transforming unit 1011 in the decrypting unit 1010 is different from that in the first embodiment. Other components and functions are the same as those in FIG. 4, which is the block diagram of the configuration of the decrypting apparatus 400 according to the first embodiment, and thus denoted by like reference numerals and redundant explanations thereof will be omitted.

The transforming unit 1011 performs mutual transformation between representation forms of various data to be handled in a decrypting process. The transforming unit 1011 is different from the transforming unit 411 according to the first embodiment in that the transforming unit 1011 transforms the plain data expressed in the projective representation into the affine representation, instead of the extension field representation.

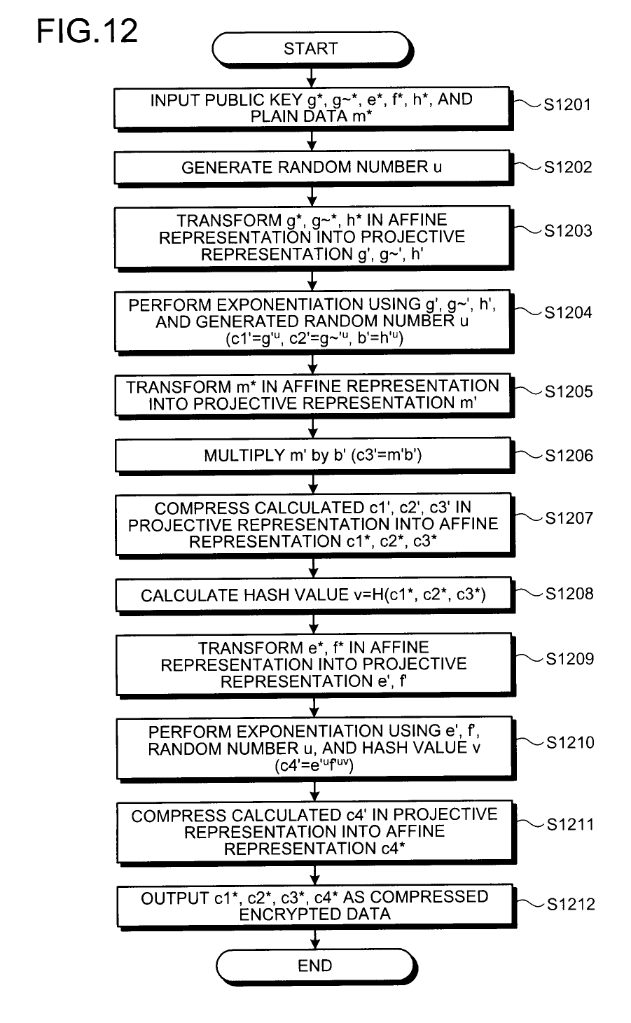

An encrypting process performed by the encrypting apparatus 900 is explained next with reference to FIG. 12.

The input unit 301 first inputs the public key data g*, g˜*, e*, f*, and h* expressed in the affine representation, and the plain data m* expressed in the affine representation (Step S1201). It is assumed in the second embodiment that the plain data is also expressed in the affine representation. The encrypting unit 910 then generates the random number u (Step S1202).

The transforming unit 911 then transforms the public key data g*, g˜*, and h* expressed in the affine representation into the projective representation g′, g˜′, and h′, respectively (Step S1203). The encrypted data calculating unit 912 then performs exponentiation c1′=g˜^{u}, c2′=g˜′^{u}, and b′=h′^{u} using the public key data g′, g˜′, and h′ transformed into the projective representation and the random number u (Step S1204).

The transforming unit 911 transforms the plain data m* expressed in the affine representation into the projective representation m′ (Step S1205). The encrypted data calculating unit 912 then calculates c3′=m′b′ by multiplying the plain data m′ transformed into the projective representation by the calculated b′ (Step S1206).

The transforming unit 911 then compresses (transforms) c1′, c2′ and c3′ expressed in the projective representation into the affine representation c1*, c2*, and c3*, respectively (Step S1207).

The encrypting unit 910 then calculates a hash value v=H(c1*, c2*, c3*) by using c1*, c2*, and c3* as inputs to the hash function H (Step S1208). The transforming unit 911 then transforms the public key data e* and f* expressed in the affine representation into the projective representation e′ and f′ (Step S1209). The encrypted data calculating unit 912 performs exponentiation c4′=e′^{u}f′^{uv} using the public key data e′ and f′ transformed into the projective representation, the random number u, and the calculated hash value v (Step S1210).

The transforming unit 911 then compresses (transforms) c4′ expressed in the projective representation into the affine representation c4* (Step S1211). The encrypting unit 910 finally outputs calculated (c1*, c2*, c3*, c4*) as encrypted data (compressed encrypted data) (Step S1212), and then terminates the encrypting process.

As described above, in the encrypting process as a whole, the load of the process of transforming the plain data m* expressed in the affine representation into the projective representation m′ (Step S1205) is increased; however, the amount of processing corresponding to four times of transformations from the extension field representation into the projective representation can be omitted. That is, with respect to the encrypted data (c1, c2, c3, c4), only the transformation from the projective representation into the affine representation is needed in the second embodiment while the transformation from the extension field representation into the affine representation is needed in the first embodiment. Therefore, the high-cost transforming processes are reduced, and therefore the processing amount is reduced. Further, the public key data is also inputted as the affine representation, and accordingly the size of the public key data to be distributed can be made smaller.

The public key data g*, g˜*, e*, f*, and h* compressed into the affine representation can be generated in the encrypting process. While the plain data expressed in the affine representation is inputted in the second embodiment, the plain data expressed in the extension field representation can be inputted like in the first embodiment.

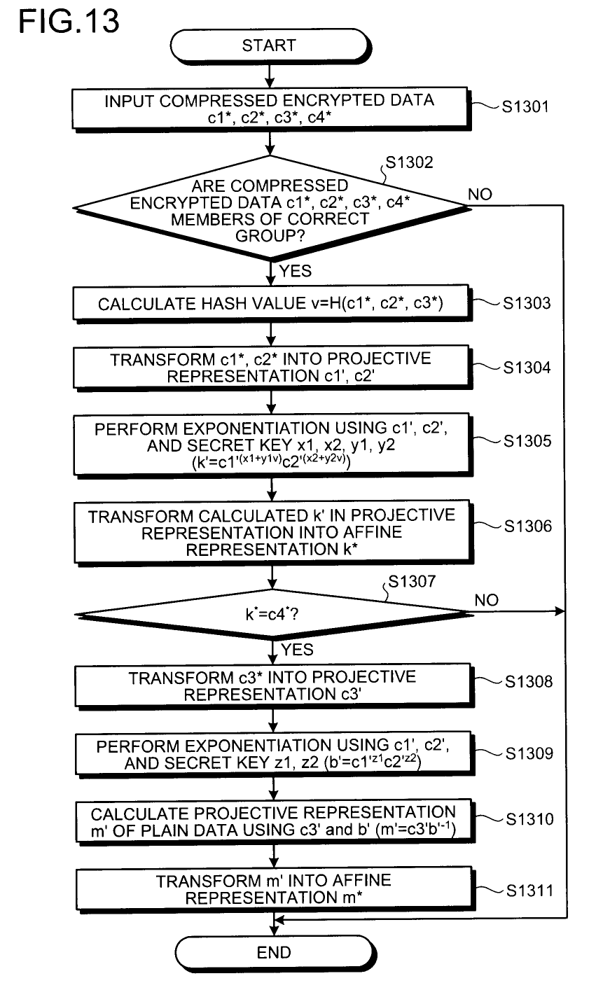

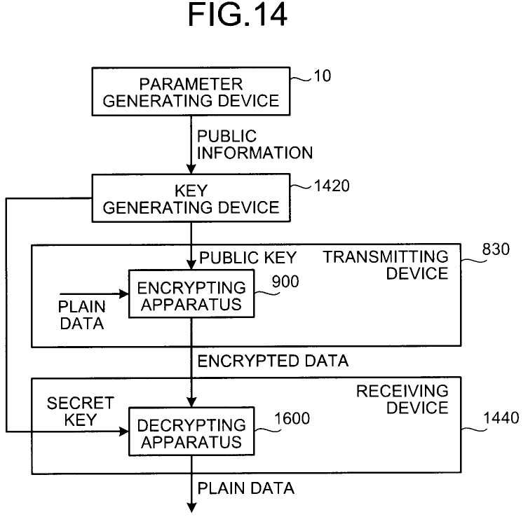

A decrypting process performed by the decrypting apparatus 1000 is explained next with reference to FIG. 13.

The decrypting process according to the second embodiment is different from that according to the first embodiment in that the transforming unit 1011 transforms the plain data expressed in the projective representation into the affine representation at Step S1311. Other processes are the same as those shown in FIG. 7, which depicts the decrypting process performed by the decrypting apparatus 400 according to the first embodiment, and thus redundant explanations thereof will be omitted.

As described above, the encryption system according to the second embodiment uses the public key data compressed into the affine representation, so that it can generate the encrypted data without performing the transformation between the extension field representation and the projective representation. Accordingly, the cost required for the computing process by the encrypting apparatus can be also reduced. Besides, the public key data is expressed in the affine representation, and therefore the size of the public key data to be distributed can be reduced.

An encryption system according to a third embodiment of the present invention applies the same method as in the second embodiment to a cryptosystem that uses a component z instead of the components z1 and z2 of the secret key data to reduce the number of components of the secret key data.

As shown in FIG. 14, the encryption system according to the third embodiment includes the parameter generating device 10, a key generating device 1420, the transmitting device 830, and a receiving device 1440.

In the third embodiment, functions of the key generating device 1420 and the receiving device 1440 are different from those in the second embodiment. Other components and functions are the same as those in FIG. 8, which is the block diagram of the encryption system according to the second embodiment, and thus denoted by like reference numerals and redundant explanations thereof will be omitted.

The key generating device 1420 is different from that of the second embodiment in that only z is used as a component of the secret key data, instead of z1 and z2, to generate the public key data.

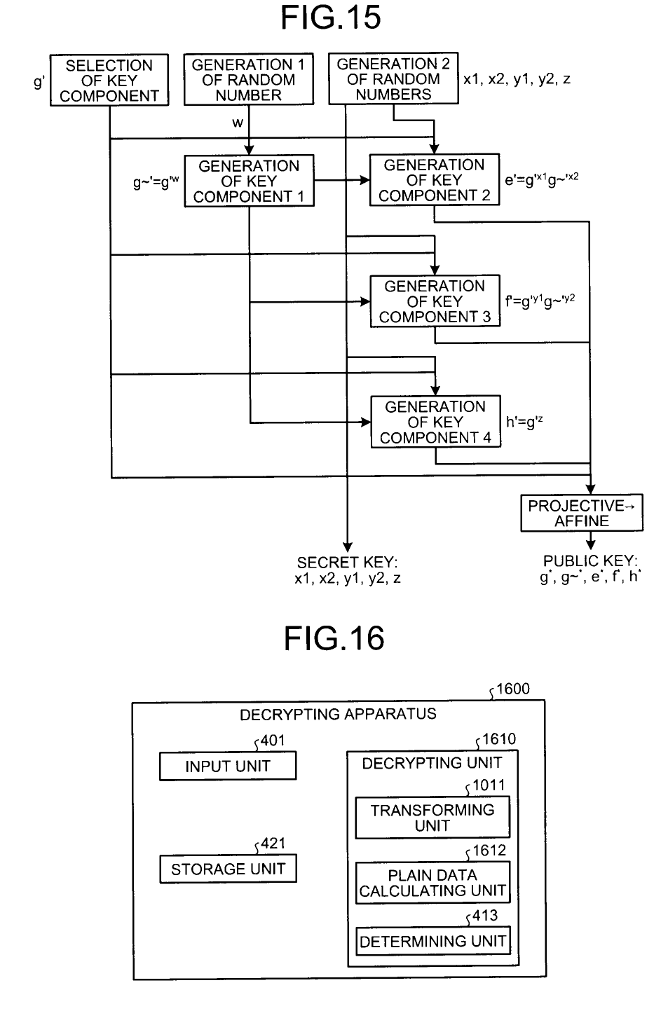

A key generating process performed by the key generating device 1420 is explained next with reference to FIG. 15.

The key generating device 1420 first selects g′ expressed in the projective representation. The key generating device 1420 then generates random numbers other than zero, w, x1, x2, y1, y2, and z. The key generating device 1420 then generates components of the public key data expressed in the projective representation, g˜′=g′^{w}, e=g′^{x1}g˜^{x2}, f′=g′^{y1}g˜′^{y2}, and h′=g′^{z}.

The key generating device 1420 then transforms the public key data g′, g˜′, e′, f′, and h′ expressed in the projective representation into public key data g*, g˜*, e*, f* and h* expressed in the affine representation, respectively. The key generating device 1420 finally outputs the secret key data x1, x2, y1, y2, and z, and the public key data g*, g˜*, e*, f*, and h* expressed in the affine representation.

As described above, in the third embodiment, the random number z is generated as the component of the secret key data, instead of z1 and z2. The component h′ of the public key data is generated only using the random number z.

The receiving device 1440 includes a decrypting apparatus 1600, which is explained below.

As shown in FIG. 16, the decrypting apparatus 1600 includes the input unit 401, the storage unit 421, and a decrypting unit 1610.

In the third embodiment, a function of a plain data calculating unit 1612 in the decrypting unit 1610 is different from that in the second embodiment. Other components and functions are the same as those in FIG. 11, which is the block diagram of the configuration of the decrypting apparatus 1000 according to the second embodiment, and thus denoted by like reference numerals and redundant explanations thereof will be omitted.

The plain data calculating unit 1612 subjects encrypted data to a decrypting process by using a cryptosystem that uses z instead of the components z1 and z2 of the secret key data to reduce the number of components of the secret key data, thereby outputting plain data, like in the cryptosystem as described in the specification of U.S. Pat. No. 7,221,758. Specifically, the plain data calculating unit 1612 is different from the plain data calculating unit 412 according to the second embodiment (or the first embodiment) in that the plain data calculating unit 1612 calculates b′ by exponentiation using c1 and the secret key data z.

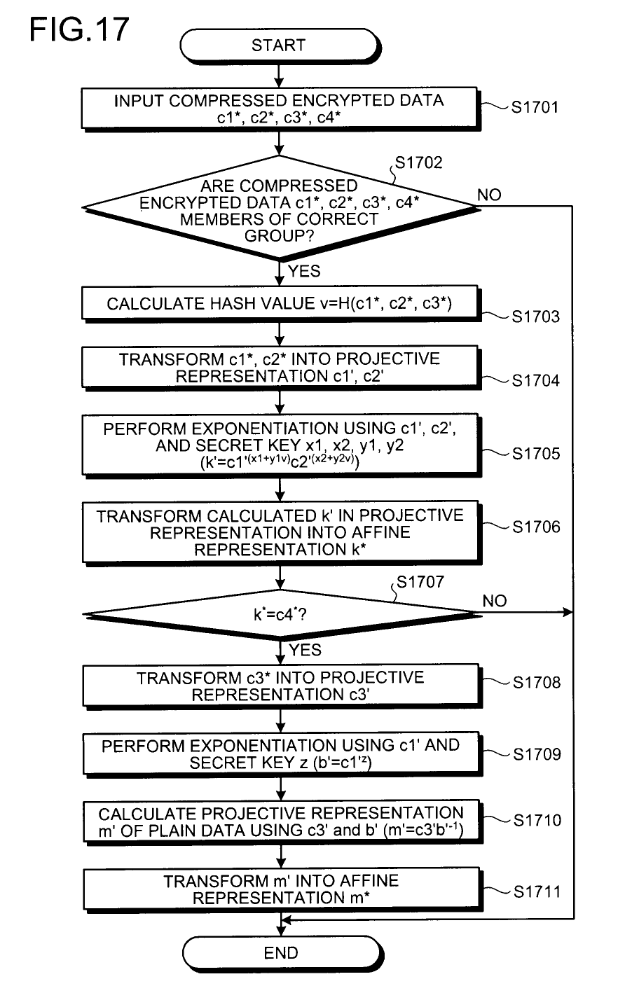

A decrypting process performed by the decrypting apparatus 1600 is explained next with reference to FIG. 17.

In the third embodiment, an exponentiating process at Step S1709 is different from the process at Step S1309 according to the second embodiment. Specifically, the plain data calculating unit 1612 performs exponentiation b′=c1′^{z} using c1′ and z of the secret key data (Step S1709). Other processes are the same as those in FIG. 13, which depicts the decrypting process performed by the decrypting apparatus 1000 according to the second embodiment, and thus redundant explanations thereof will be omitted.

As described above, the encryption system according to the third embodiment can apply the same method as in the second embodiment to the cryptosystem that reduces the components of the secret key data to five components of x1, x2, y1, y2, and z.

An encryption system according to a fourth embodiment of the present invention applies the same method as in the second embodiment to a cryptosystem that uses x instead of the components x1 and x2 of the secret key data, y instead of y1 and y2, and z instead of z1 and z2, and handles w as a component of the secret key data.

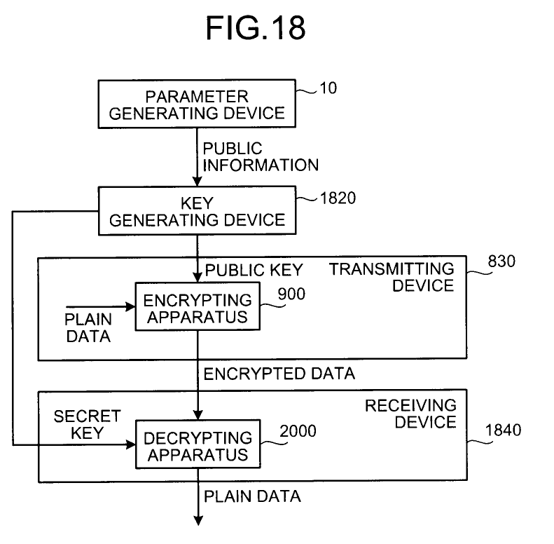

As shown in FIG. 18, the encryption system according to the fourth embodiment includes the parameter generating device 10, a key generating device 1820, the transmitting device 830, and a receiving device 1840.

In the fourth embodiment, functions of the key generating device 1820 and the receiving device 1840 are different from those in the second embodiment. Other components and functions are the same as those shown in FIG. 8, which is the block diagram of the encryption system according to the second embodiment, and thus denoted by like reference numerals and redundant explanations thereof will be omitted.

As described above, the key generating device 1820 is different from that in the second embodiment in that the key generating device 1820 generates the public key data only using x, y, and z as components of the secret key data, and handles w as a component of the secret key data.

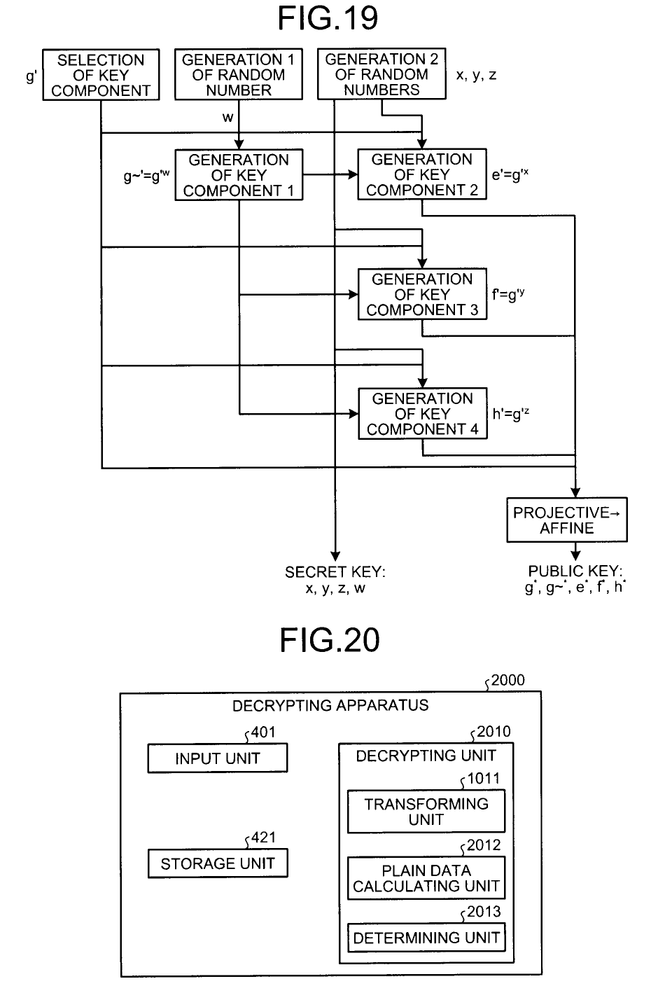

A key generating process performed by the key generating device 1820 is explained next with reference to FIG. 19.

The key generating device 1820 first selects g′ expressed in the projective representation. The key generating device 1820 then generates random numbers other than zero, w, x, y, and z. The key generating device 1820 then generates components of the public key data expressed in the projective representation, g˜′=g′^{w}, e′=g′^{x}, f′=g′^{y}, and h′=g′^{z}.

The key generating device 1820 transforms the public key data g′, g˜′, e′, f′, and h′ expressed in the projective representation into the public key data g*, g˜*, e*, f*, and h* expressed in the affine representation, respectively. The key generating device 1820 finally outputs the secret key data x, y, z, and w, and the public key data g*, g=*, e*, f*, and h* expressed in the affine representation.

The receiving device 1840 includes a decrypting apparatus 2000 explained below.

As shown in FIG. 20, the decrypting apparatus 2000 includes the input unit 401, the storage unit 421, and a decrypting unit 2010.

In the fourth embodiment, functions of a plain data calculating unit 2012 and a determining unit 2013 in the decrypting unit 2010 are different from those in the second embodiment. Other components and functions are the same as those shown in FIG. 11, which is the block diagram of the configuration of the decrypting apparatus 1000 according to the second embodiment, and thus denoted by like reference numerals and redundant explanations thereof will be omitted.

The plain data calculating unit 2012 subjects encrypted data to a decrypting process using the cryptosystem that uses x, y, z, and w as the components of secret key data, to output the plain data. For example, the plain data calculating unit 2012 calculates k′=c1′^{x}c2′^{yv}, and l′=c1′^{w} by using the hash value v, the encrypted data c1′ and c2′, and the secret key data w, x, and y.

The determining unit 2013 is different from the determining unit 413 according to the second embodiment in that the determining unit 2013 determines validity of the encrypted data using l*, which is obtained by transforming l′ into the affine representation, as well as k*, which is obtained by transforming k′ into the affine representation.

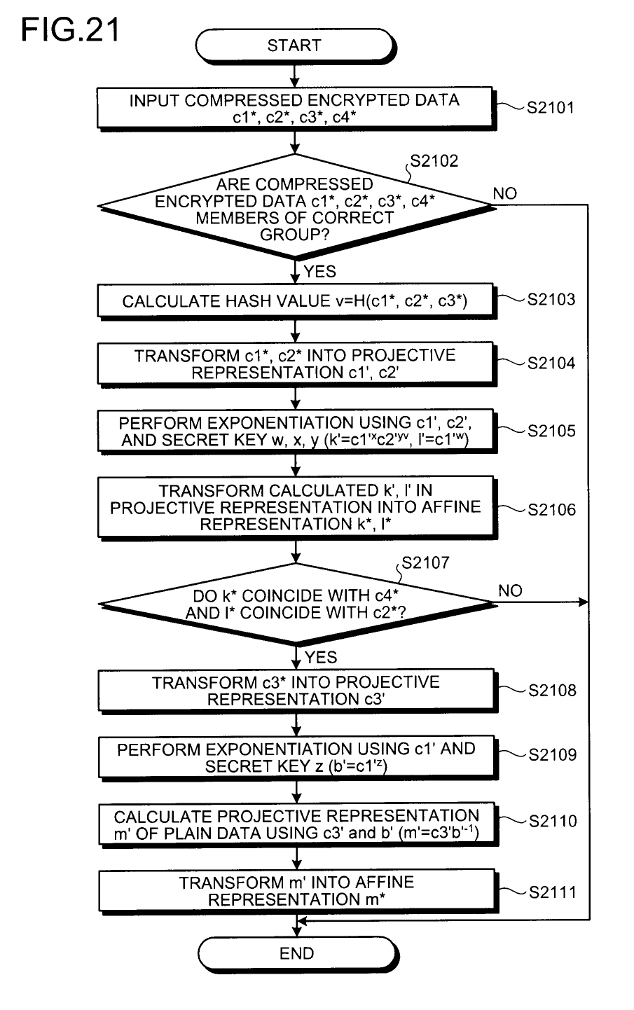

A decrypting process performed by the decrypting apparatus 2000 is explained next with reference to FIG. 21.

A encrypted data input process, a element determining process, a hash-value calculating process, and a transforming process from Steps S2101 to S2014 are the same as those from Step S1301 to S1304 performed by the decrypting apparatus 1000 according to the second embodiment. Therefore, redundant explanations thereof will be omitted.

After Step S2104, the plain data calculating unit 2012 performs exponentiations k′=c1′^{x}c2′^{yv} and l′=c1′^{w} using the hash value v, c1′ and c2′, and w, x, and y of the secret key data (Step S2105). The transforming unit 411 then transforms k′ and l′ expressed in the projective representation into the affine representation k* and l*, respectively (Step S2106).

The determining unit 2013 then determines whether k* and c4* coincide with each other, and l* and c2* coincide with each other (Step S2107). When they do not coincide (NO at Step S2107), the decrypting process is terminated. When they coincide (YES at Step S2107), the transforming unit 411 transforms c3* expressed in the affine representation into the projective representation c3′, like in the second embodiment (Step S2108).

The plain data calculating unit 2012 then performs exponentiation b′=c1′^{z} using c1′ and z of the secret key data (Step S2109).

A plain data calculating process and a plain data transforming process at Steps S2110 and S2111 are the same as those at Step S1310 and S1311 performed by the decrypting apparatus 1000 according to the second embodiment. Therefore, redundant explanations thereof will be omitted.

As described above, in the encryption system according to the fourth embodiment, the same method as in the second embodiment can be applied also to the cryptosystem that reduces the number of components of secret key data to be used to four (w, x, y, and z).

Hardware configurations of the encrypting apparatuses and the decrypting apparatuses according to the first to fourth embodiments are explained below. The encrypting apparatuses and the decrypting apparatuses according to the first to fourth embodiments each include a controller such as a central processing unit (CPU), memories such as a read only memory (ROM) and a random access memory (RAM), a communication interface (I/F) for connecting to a network to perform communication, and a bus for connecting these units.

Decrypting programs executed by the decrypting apparatuses according to the first to fourth embodiments are previously installed in the ROM, or the like.

The decrypting programs executed by the decrypting apparatuses according to the first to fourth embodiments can be recorded on a computer-readable recording medium such as a compact disk read only memory (CD-ROM), a flexible disk (FD), a CD recordable (CD-R), or a digital versatile disk (DVD) in a file of an installable or executable format, and provided.

The decrypting programs executed by the decrypting apparatuses according to the first to fourth embodiments each have a module configuration including the units described above (the input unit and the decrypting unit). As practical hardware, the CPU reads the decrypting program from the ROM and executes the decrypting program, to load the units in a maim memory, so that the units are generated in the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An encrypting apparatus that encrypts plain data by a cryptosystem based on a discrete logarithm problem on a subgroup of a multiplicative group, the apparatus comprising:
an input unit that inputs the plain data and encryption key data, the encryption key data including components at least a part of which is a element of the subgroup and expressed in an affine representation;
a first transforming unit that transforms the component expressed in the affine representation into a component expressed in a projective representation;
an encrypted data calculating unit that subjects the plain data to an encrypting process previously defined by the cryptosystem using the encryption key data including the component expressed in the projective representation, thereby calculating encrypted data expressed in the projective representation; and
a second transforming unit that transforms at least a part of the encrypted data expressed in the projective representation into the affine representation.

2. The apparatus according to claim 1, wherein
the input unit inputs the plain data expressed in the affine representation, and the encryption key data at least a part of which is expressed in the affine representation,
the first transforming unit further transforms the plain data expressed in the affine representation into the projective representation, and
the encrypted data calculating unit subjects the plain data transformed into the projective representation to the encrypting process using the encryption key data including the component expressed in the projective representation, thereby calculating the encrypted data expressed in the projective representation.

3. The apparatus according to claim 1, wherein
the input unit inputs the plain data expressed in an extension field representation, and the encryption key data at least a part of which is expressed in the affine representation,
the first transforming unit further transforms the plain data expressed in the extension field representation into the projective representation, and
the encrypted data calculating unit subjects the plain data transformed into the projective representation to the encrypting process using the encryption key data including the component expressed in the projective representation, thereby calculating the encrypted data expressed in the projective representation.

4. The apparatus according to claim 1, further comprising:
a hash-value calculating unit that calculates a hash value of data inputted thereto, wherein
at least a part of the inputted data to the hash-value calculating unit includes a encrypted data component expressed in the affine representation.

5. The apparatus according to claim 1, wherein the cryptosystem is a Cramer-Shoup cryptosystem.

6. The apparatus according to claim 1, wherein the cryptosystem is based on the discrete logarithm problem on the subgroup that is an algebraic torus.

7. A decrypting apparatus that decrypts encrypted data encrypted by a cryptosystem based on a discrete logarithm problem on a subgroup of a multiplicative group, the apparatus comprising:
an input unit that inputs the encrypted data including at least a component that is a element of the subgroup and expressed in an affine representation;
a transforming unit that transforms the encrypted data into projective representation data expressed in a projective representation; and
a plain data calculating unit that subjects the projective representation data to a decrypting process previously defined by the cryptosystem, thereby calculating decrypted plain data expressed in the projective representation.

8. The apparatus according to claim 7, wherein
the input unit inputs the encrypted data including plural elements at least a part of which is expressed in the affine representation,
the transforming unit transforms each of the elements included in the encrypted data into the projective representation, and
the plain data calculating unit performs the decrypting process using the plural elements transformed into the projective representation, thereby calculating the decrypted plain data expressed in the projective representation.

9. The apparatus according to claim 7, further comprising:
a determining unit that calculates a hash value of the inputted encrypted data, and determines validity of the inputted encrypted data based on the calculated hash value, wherein
the plain data calculating unit subjects the projective representation data to the decrypting process when the inputted encrypted data is determined to be valid, thereby calculating the decrypted plain data expressed in the projective representation.

10. The apparatus according to claim 7, wherein the transforming unit further transforms the calculated decrypted plain data into an extension field representation.

11. The apparatus according to claim 7, wherein the transforming unit further transforms the calculated decrypted plain data into an affine representation.

12. The apparatus according to claim 7, wherein the cryptosystem is a Cramer-Shoup cryptosystem.

13. The apparatus according to claim 7, wherein the cryptosystem is based on the discrete logarithm problem on the subgroup that is an algebraic torus.

14. An encrypting method that encrypts plain data by a cryptosystem based on a discrete logarithm problem on a subgroup of a multiplicative group, the method comprising:
inputting the plain data and encryption key data, the encryption key data including components at least a part of which is a element of the subgroup and expressed in an affine representation;
transforming the component expressed in the affine representation into a component expressed in a projective representation;
subjecting the plain data to an encrypting process previously defined by the cryptosystem using the encryption key data including the component expressed in the projective representation, thereby calculating encrypted data expressed in the projective representation; and
transforming at least a part of the encrypted data expressed in the projective representation into the affine representation.

15. A decrypting method that decrypts encrypted data encrypted by a cryptosystem based on a discrete logarithm problem on a subgroup of a multiplicative group, the method comprising:
inputting the encrypted data that is a element of the subgroup and expressed in an affine representation;
transforming the encrypted data into projective representation data expressed in a projective representation; and
subjecting the projective representation data to a decrypting process previously defined by the cryptosystem, thereby calculating plain data expressed in the projective representation.

16. A computer program product having a computer readable medium including programmed instructions for encrypting plain data by a cryptosystem based on a discrete logarithm problem on a subgroup of a multiplicative group, wherein the instructions, when executed by a computer, cause the computer to perform:
inputting the plain data and encryption key data, the encryption key data including components at least a part of which is a element of the subgroup and expressed in an affine representation;
transforming the component expressed in the affine representation into a component expressed in a projective representation;
subjecting the plain data to an encrypting process previously defined by the cryptosystem using the encryption key data including the component expressed in the projective representation, thereby calculating encrypted data expressed in the projective representation; and
transforming at least a part of the encrypted data expressed in the projective representation into the affine representation.

17. A computer program product having a computer readable medium including programmed instructions for decrypting encrypted data encrypted by a cryptosystem based on a discrete logarithm problem on a subgroup of a multiplicative group, wherein the instructions, when executed by a computer, cause the computer to perform:
inputting the encrypted data that is a element of the subgroup and expressed in an affine representation;
transforming the encrypted data into projective representation data expressed in a projective representation; and
subjecting the projective representation data to a decrypting process previously defined by the cryptosystem, thereby calculating plain data expressed in the projective representation.
